(19) United States
(12) Patent Application Publication
(10) Pub. No.: US 2023/0344314 A1
(43) Pub. Date: Oct. 26, 2023

(54) ROTARY ELECTRIC MACHINE

(71) Applicant: Mitsubishi Electric Corporation, Tokyo (JP)

(72) Inventors: Hiroki NAGAMURA, Tokyo (JP); Yuzuru KOBAYASHI, Tokyo (JP); Yoshiro IMAZAWA, Tokyo (JP)

(73) Assignee: Mitsubishi Electric Corporation, Tokyo (JP)

(21) Appl. No.: 18/158,571

(22) Filed: Jan. 24, 2023

(30) Foreign Application Priority Data
Apr. 21, 2022 (JP) 2022-069826

(51) Int. Cl. H02K 9/28; H02K 5/14

(52) U.S. Cl. CPC H02K 9/28; H02K 5/141

(57) ABSTRACT

This machine includes: a rotor; sliprings that are placed on an outer circumferential surface of an end portion of a shaft located on one end side thereof and projecting from the rotor; a brush assembly that has a cylindrical shape with an open end located near a head of the shaft, to thereby surround the sliprings; and brushes that penetrate in the brush assembly toward the sliprings from their radially outer sides and make contact with the sliprings, for supplying a current to the sliprings; wherein, on an inner circumferential surface of the brush assembly near the open end, a first wall that extends in a circumferential direction and a second wall that forms, between it and the first wall, a flow passage that leads in the circumferential direction from a region corresponding to a penetrating region of the brush, to an outside thereof, are formed.

### BACKGROUND OF THE INVENTION

### 1. Field of the Invention

The present application relates to a rotary electric machine.

### 2. Description of the Background Art

Among rotary electric machines, rotary electric machines with brushes such as alternators, motor generators, etc. for use in vehicles are required to be provided with air permeability for getting cooled. However, under actual use conditions, these machines may be soaked with liquids.

In this regard, there is disclosed a rotary electric machine provided with a fitting sleeve serving as both a brush holder and a slipring cover, in which a single web is provided in a region inside the fitting sleeve and near an end edge portion thereof, so that the rotary electric machine is both air-permeable and capable of blocking a liquid from intruding internally (see, for example, Patent Document 1). Further, there is disclosed a rotary electric machine in which a labyrinth seal for changing a fluid flow from axial to radial is formed at an end portion of the brush holder or the slipring cover, so that the rotary electric machine is both air-permeable and capable of preventing intrusion of a foreign substance (see, for example, Patent Document 2).
Patent Document 1: U.S. Pat. No. 9,024,503 (Column 5, Paragraph 3; FIG. 5)
Patent Document 2: German Patent Application Publication No. 102013200893 (Paragraphs 0035 to 0036; FIG. 4 and FIG. 5)

However, in the case where the brush assembly is segmented into multiple components as represented by the combination of the brush holder and the slipring cover, a slight gap is formed between the components. Further, according to such a barrier-forming structure as disclosed in the foregoing Patent Documents, even though a liquid is prevented from being splashed directly to the slipring or the brush, it may partially remain in the inner side of the barrier. Accordingly, a case may arise where the liquid remaining in the inner side of the barrier reaches the slipring or the brush by later vibrations or the like and thus, it is difficult only by simply forming the barrier, to prevent a liquid from intruding to the brush. Thus, impurities such as a salt, etc. included in the liquid may be firmly adhered to and accumulated on the brush, so that the operation or power generation of the rotary electric machine may possibly be stopped due to sticking of the brush.

### SUMMARY OF THE INVENTION

This application discloses a technique for solving such a problem as described above, and an object thereof is to provide a rotary electric machine which can prevent a liquid from intruding to the brush.

A rotary electric machine disclosed in this application is characterized by comprising: an annular stator; a rotor having a field winding and located on an inner circumferential-surface side of the stator; a shaft that rotatably supports the rotor and is provided with a slipring for supplying a current to the field winding, said slipring being placed on an outer circumferential surface of an end portion of the shaft located on its one end side and projecting from the rotor; a brush assembly that has a cylindrical shape with an open end located near a head of the shaft, to thereby surround the slipring; and a brush that penetrates in the brush assembly toward the slipring from its radially outer side and makes contact with the slipring, for supplying a current to the slipring;
wherein a first wall and a second wall are formed on an inner circumferential surface of the brush assembly between the open end and the brush, said first wall extending in a circumferential direction while projecting radially inwardly, and said second wall being placed to be spaced apart from the first wall on its side closer to the brush than the first wall, and forming between it and the first wall, a flow passage that leads in the circumferential direction from a region corresponding to a penetrating region of the brush, to an outside thereof.

According to the rotary electric machine disclosed in this application, since the flow passage sandwiched by the spaced-apart walls and extending in the circumferential direction is formed on the inner circumferential surface of the brush assembly, it is possible to prevent a liquid from intruding to the brush.

### BRIEF DESCRIPTION OF THE DRAWINGS

FIG. 1 is a cross-sectional view for illustrating a configuration of a rotary electric machine according to Embodiment 1, viewed along a rotation axis thereof.

FIG. 2 is an assembly diagram about a brush assembly for constituting the rotary electric machine according to Embodiment 1.

FIG. 3 is a side view of the brush assembly for constituting the rotary electric machine according to Embodiment 1, viewed axially from the side of a protective cover.

FIG. 4 is a cross-sectional view of the brush assembly for constituting the rotary electric machine according to Embodiment 1, viewed along the rotation axis.

FIG. 5 is a perspective view of the brush assembly for constituting the rotary electric machine according to Embodiment 1, when it is cut along the rotation axis.

FIG. 6 is a perspective view of a brush assembly for constituting a rotary electric machine according to Embodiment 2, when it is cut along a rotation axis of that machine.

### DETAILED DESCRIPTION OF THE EMBODIMENTS OF THE INVENTION

### Embodiment 1

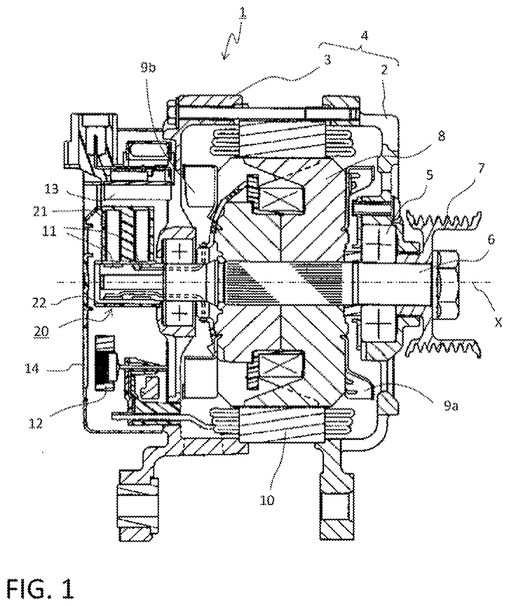

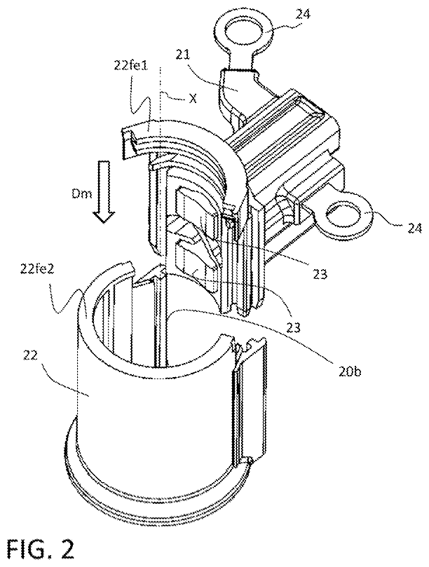

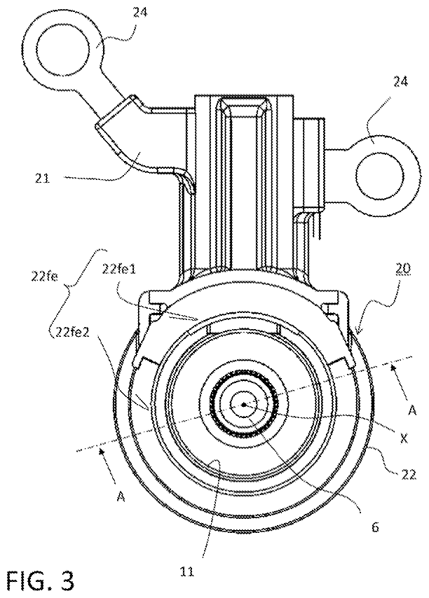

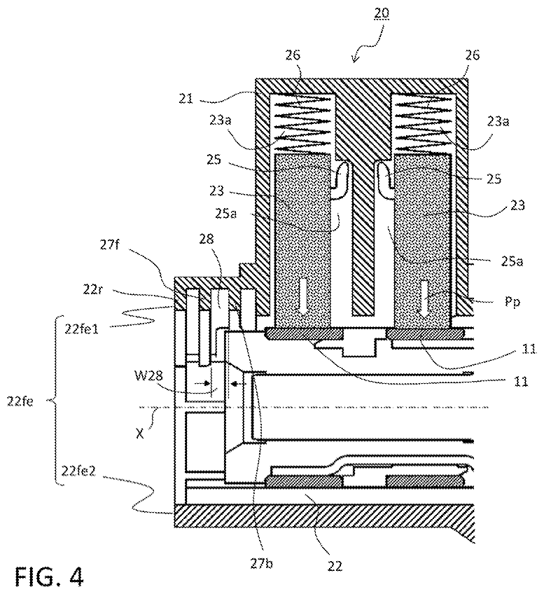

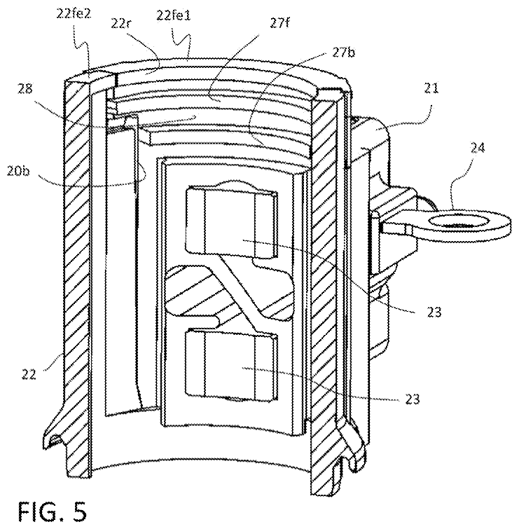

FIG. 1 to FIG. 5 serve for explaining a configuration of a rotary electric machine according to Embodiment 1, in which FIG. 1 is a cross-sectional view including a rotation axis of the rotary electric machine and being parallel to a pressing direction of a brush; FIG. 2 is an assembly diagram showing how a brush holder is combined with a slipring cover to assemble a brush assembly; FIG. 3 is a side view showing a state of the brush assembly, viewed from a position axially spaced apart therefrom on the side of a protective cover; and FIG. 4 is an enlarged cross-sectional view of the brush assembly corresponding to a part of FIG. 1. Further, FIG. 5 is a perspective view showing a state of the brush assembly when it is cut along an A-A line shown in FIG. 3.

A rotary electric machine 1 according to Embodiment 1 is a rotary electric machine with a brush for use in vehicles, which includes, as shown in FIG. 1, an annular stator 10, a rotor 8 that is located on the radially inner side of the stator 10 and is rotatably supported there, and a brush assembly 20 for transferring activation power to the rotor 8. Further, it includes a casing 4 which is formed by a combination of a front bracket 2 and a rear bracket 3 that are made of aluminum and are each almost bowl-shaped, and in which the stator 10, the rotor 8 and the brush assembly 20 are accommodated.

The rotor 8 is supported in the casing 4 by a shaft 6 that has a fan 9a and a fan 9b fixed at both end faces of that shaft in terms of the direction of an axis (rotation axis X), and that is rotatably supported by the casing 4 through a pair of bearings 5. In addition, a pulley 7 is firmly fixed to the shaft 6 at its end portion extending toward the front side (right side in this figure). Further, the stator 10 is fixed to the casing 4 on its inner circumferential-surface side so as to surround the rotor 8 through an unshown gap.

A pair of sliprings 11 for supplying a current to the rotor 8 is fixed to an outer circumferential surface of the shaft 6 at its extending portion extending toward the rear side (left side in this figure) of the casing 4 and projecting outward from the rear bracket 3. On the outer circumferential side of the sliprings 11, a rectifier 12 for rectifying an AC voltage generated in the stator 10, that is fabricated almost into a C-shape, is disposed to form in a plane perpendicular to the rotation axis X, a fan-like shape around the shaft 6.

Here, the aforementioned brush assembly 20 is configured with a combination of a brush holder 21 interposed between both ends of the almost C-shaped rectifier 12 and a slipring cover 22, etc., and is disposed on an outer circumferential side of the extending portion of the shaft 6 so as to cover the pair of sliprings 11. To the brush assembly 20, a voltage regulator 13 for regulating the magnitude of the AC voltage generated in the stator 10 is attached.

On the rear side of the rear bracket 3, an unshown connector for performing signal input/output between the voltage regulator 13 and an unshown external device or the like, is located. Further, a protective cover 14 made of an insulating resin is attached to the rear bracket 3 so as to cover the aforementioned connector, the rectifier 12, the brush holder 21 and the voltage regulator 13.

Next, the brush assembly 20 will be detailed. As shown in FIG. 2, the brush assembly 20 is configured with a combination of the brush holder 21 that is interposed between both ends of the almost C-shaped rectifier 12, and the slipring cover 22 that is made of a resin and formed into a C-shape so as to cover the sliprings 11 as described above. Here, relative to the slipring cover 22, the brush holder 21 is inserted in a direction Dm along the rotation axis X so that their respective end edge surface 22fe2 and end edge surface 22fe1 are matched with each other, to thereby form an end edge portion 22fe serving as an open end. This results in the brush assembly 20 as shown in FIG. 3.

Namely, an arc-like wall member as the slipring cover 22 that constitutes a majority of the circumferential portion, is combined with an arc-like part of the brush holder 21 that constitutes less than half of the circumferential portion, to thereby form a cylindrical shape which surrounds the sliprings 11 and whose end portion corresponding to a head of the shaft 6 forms an open end.

As shown in FIG. 4, the brush holder 21 is configured with: a pair of brushes 23 respectively corresponding to the pair of sliprings 11; pig tails 25 electrically connecting the respective brushes 23 with connection terminals 24 to be described later; springs 26; and the like.

In the brush holder 21, brush storage sections 23a are formed in which the brushes 23 and the springs 26 for pressing the respective brushes 23 against the respective opposite-side surfaces of the paired sliprings 11 (positive and negative electrodes) with a pressing force Pp directed to the radially inner side of the sliprings 11, are stored. Furthermore, pig-tail storage sections 25a are formed in which the pig tails 25 that are soldered to the connection terminals 24 embedded in the brush holder 21 and are electrically connected with the brushes 23 are stored.

With such a configuration, even if the brush 23 is abraded due to sliding on the slipring 11 caused by the rotation of the slipring 11, the brush 23 is pressed constantly against the slipring 11 because of the repulsion force from the spring 26. This makes it possible to continuously establish the electrical connection therebetween.

The configuration described so far is similar to that of a conventional rotary electric machine, so that a characteristic configuration of the rotary electric machine 1 according to Embodiment 1 will be described on the premise of the above configuration.

As shown in FIG. 5, on a portion of the inner circum-ferential surface of the brush assembly 20 at around a part of the end edge portion 22fe on the brush holder 21-side (namely, at around the end edge surface 22fe1), a rib 22r that extends in a circumferential direction while projecting toward the rotation axis X is formed, so that intrusion of a liquid coming from the end edge portion 22fe-side is prevented. Furthermore, on a portion of the inner circumferential surface on the brush holder 21-side, that is axially closer to the brush 23 than the rib 22r, a first wall 27f and a second wall 27b that extend in a circumferential direction while projecting toward the rotation axis X, are formed to be axially spaced apart from each other.

By the way, according to the conventional rotary electric machine for use in vehicles, intrusion of a liquid applied from the rear side can be somewhat prevented by means of the protective cover; however, a case may arise where the liquid reaches the brush holder or the slipring cover. The liquid adhered to the brush holder or the slipring cover is a liquid that has intruded from the side of the end edge surface of the brush holder or through a gap between components. Since impurities such as a salt, etc. are included in the thus-intruded liquid, these impurities, when dried, will be tightly adhered to the inside of the brush holder or the slipring cover. These impurities may be accumulated through repeated drying and adhesion, to reach the brush. If the brush is sticked with the salt, etc., the function of pressing the brush against the slipring by using the repulsion force of the spring will be suppressed. When the thus-sticked brush is abraded due to sliding on the slipring, a gap will be created and the electrical connection point will disappear, thus resulting in stoppage of the operation or power generation of the rotary electric machine for use in vehicles.

Accordingly, it is conceivable to prevent a liquid from intruding to the slipring or the brush by forming the barrier as explained in “Description of the Background Art”. However, by merely forming the barrier, a case may arise where, even though direct splash of the liquid is prevented, the liquid partially remains in the inner side of the barrier and the remaining liquid reaches the slipring or the brush by later vibrations or the like. Thus, it is difficult to prevent a liquid from intruding to the brush.

In contrast, in the rotary electric machine 1 according to Embodiment 1, on a portion of the inner circumferential surface of the brush assembly 20 on the brush holder 21-side, the first wall 27f and the second wall 27b that project toward the rotation axis X and are arc-like, are formed to be axially spaced apart from each other. Between the first wall 27f and the second wall 27b, a flow passage 28 that leads to an outside of the region of the brush holder 21 is formed along the circumferential direction.

Accordingly, if a liquid passes through the first wall 27f that is positioned closer to the end edge portion 22fe than the flow passage 28 and serves to prevent a liquid from being splashed directly toward the slipring 11 or the brush 23, it will be kept staying in the flow passage 28 between that wall and the second wall 27b. Even if the staying liquid is subjected to vibrations or impacts due to travelling of a vehicle, it will go to the outside of the region of the brush holder 21 (an arrangement region of the brushes 23), not along the axial direction but along the circumferential direction in the flow passage 28.

This makes it possible, if the remaining liquid is subjected to vibrations or impacts, or if there is a liquid having passed through a boundary portion 20b between the brush holder 21 and the slipring cover 22, to guide such a liquid in a circumferential direction, to thereby prevent it from intruding toward the brush 23. Moreover, since multiple concavities and convexities are formed along the axial direction, the surface area of the inner circumferential surface increases, so that the liquid will be dried more easily. Thus, if impurities such as a salt, etc. are going to be accumulated, they become more difficult to reach the brush 23, so that the sticking of the brush 23 is suppressed.

On that occasion, when the width of the flow passage 28 (flow-passage width W28: FIG. 4) is set to be not less than 1 mm, it is possible to smoothly guide the liquid remaining in the flow passage 28, along the circumference direction, to the outside of the region of the brush 23. Further, when the flow-passage width W28 is set to be not more than 10 mm, it is possible to prevent the liquid, even if it is subjected to vibrations or impacts, from axially going beyond the second wall 27b, and to guide the liquid along the circumferential direction in the flow passage 28.

### Embodiment 2

In Embodiment 1, a case has been described where the flow passage having a uniform width is formed along a circumferential direction by using two walls. In Embodiment 2, a case will be described where the end portions of the second wall are bent toward the brush so that the flow-passage width thereat expands toward the brush.

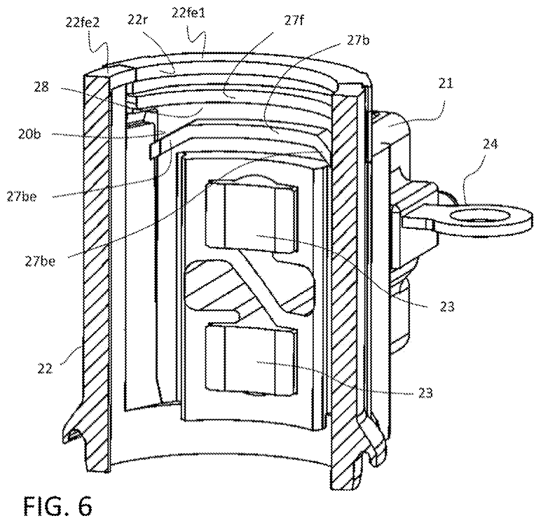

FIG. 6 serves for explaining a configuration of the rotary electric machine according to Embodiment 2, and is a perspective view showing a state of its brush assembly when it is cut along a line corresponding to the A-A line shown in FIG. 3 that is used in the description of Embodiment 1. Note that, other than the second wall and the flow passage, the configuration is the same as that of Embodiment 1, so that description of the same parts will be omitted and FIG. 1 to FIG. 4 used in Embodiment 1 are also employed here.

In Embodiment 1, the first wall 27f and the second wall 27b formed on the inner circumferential surface on the side of the brush holder 21 as a slipring holder, are each configured to extend along a plane perpendicular to the axial direction. However, in Embodiment 2, as shown in FIG. 6, with respect to the second wall 27b that is closer to the brush 23 than the first wall 27f, both end portions 27be thereof in a circumferential direction are bent toward the brush 23, and in accordance therewith, the flow passage 28 (flow-passage width W28) expands, at its both end sides in the circumferential direction, toward the brush 23.

Since the both end portions 27be in the circumferential direction of the second wall 27b that is closest to the brush 23 are bent toward the brush 23, the liquid having entered in the flow passage 28 will go using its kinetic energy, more smoothly along the circumferential direction to the outside of the arrangement region of the brush 23. This enhances the effect of capturing a liquid that has intruded, for example, through the boundary portion 20b between the brush holder 21 and the slipring cover 22 to thereby prevent the liquid from flowing in toward the brash 23.

Accordingly, it becomes possible to suppress the sticking of the brush 23 more significantly. On that occasion, it is preferable that the flow-passage width W28 at a middle portion in the circumferential direction of the flow passage (its portion corresponding to the projecting region of the brush 23) be within the range shown in Embodiment 1; however, the width at its portions closer to the both ends than the middle portion may be wider than that range.

It should be noted that, in this application, a variety of exemplary embodiments and examples have been described; however, every characteristic, con-figuration or function that has been described in one or more embodiments, is not limited to being applied to a specific embodiment, and may be applied singularly or in any of various combinations thereof to another embodiment. Accordingly, an infinite number of modified examples that have not been exemplified here are supposed within the technical scope disclosed in the present description. For example, such cases shall be included where at least one configuration element is modified; where at least one configuration element is added or omitted; and furthermore, where at least one configuration element is extracted and combined with a configuration element disclosed in another embodiment.

For example, although such cases have been shown where one flow passage 28 is formed by the first wall 27f and the second wall 27b, this is not limitative. Multiple flow passages may be formed by forming a much larger number of walls, for example, additionally forming a third wall and a fourth wall. Further, a flow passage may be formed between the rib 22r and the first wall 27f. Further, such embodiments have been shown in which the brush assembly 20 is a combination of the slipring cover 22 and the brush holder 21 that are divided in a circumferential direction, and has the boundary portion 20b therebetween; however, the brush holder is not limited thereto, and may be seamlessly combined.

As described above, the rotary electric machine 1 of this application is configured to comprise: the annular stator 10; the rotor 8 having a field winding and located on an inner circumferential-surface side of the stator 10 so as to be rotatably supported coaxially with the stator 10 on the inner circum-ferential-surface side thereof; the shaft 6 that rotatably supports the rotor 8 and is provided with the sliprings 11 for supplying a current to the field winding, said sliprings being placed on an outer circumferential surface of an end portion of the shaft located on its one end side and projecting from the rotor 8; the brush assembly 20 that has a cylindrical shape with an open end located near a head of the shaft 6, to thereby surround the sliprings 11; and the brushes 23 that penetrate in the brush assembly 20 toward the sliprings 11 from their radially outer sides and make contact with the sliprings 11, for supplying a current to the sliprings 11;

wherein the first wall 27f and the second wall 27b are formed on an inner circumferential surface of the brush assembly 20 between the open end (end edge portion 22fe) and the brushes 23, said first wall extending in a circumferential direction while projecting radially inwardly, and said second wall being placed to be spaced apart from the first wall 27f on its side closer to the brushes 23 than the first wall, and forming between it and the first wall 27f, a flow passage that leads in the circumferential direction from a region corresponding to the penetrating region of the brushes 23, to the outside thereof. With this configuration, it is possible to prevent a liquid from being splashed directly to the sliprings 11 or the brushes 23. Moreover, if the liquid passes through the first wall 27f, the liquid staying in the flow passage 28 between that wall and the second wall 27b, even if it is subjected to vibrations or impacts due to travelling of a vehicle, will go in the flow passage 28 to the outside of the region of the brush holder 21, not along the axial direction but along the circumferential direction in the flow passage 28. Thus, it is possible to prevent a liquid from intruding to a contact portion between the brush 23 and the slipring 11.

In particular, with such a configuration in which, as the flow passage 28 goes toward both ends thereof in the circumferential direction, it expands so as to become closer to the brush 23, it is possible to enhance the effect of capturing a liquid that has intruded through the boundary portion 20b between the brush holder 21 and the slipring cover 22 to thereby prevent the liquid from flowing in toward the brash 23.

In addition, when the width of the flow passage 28 in an axial direction (flow-passage width W28) at a region in the circumferential direction corresponding to the penetrating region of the brush 23, is set to be not less than 1 mm but not more than 10 mm, the liquid remaining in the flow passage 28, even if it is subjected to vibrations or impacts, can be guided smoothly along the circumference direction in the flow passage 28 without going beyond the second wall 27b.

What is claimed is:

1. A rotary electric machine, comprising:
an annular stator;
a rotor having a field winding and located on an inner circumferential-surface side of the stator;
a shaft that rotatably supports the rotor and is provided with a slipring for supplying a current to the field winding, said slipring being placed on an outer circumferential surface of an end portion of the shaft located on its one end side and projecting from the rotor;
a brush assembly that has a cylindrical shape with an open end located near a head of the shaft, to thereby surround the slipring; and
a brush that penetrates in the brush assembly toward the slipring from its radially outer side and makes contact with the slipring, for supplying a current to the slipring;
wherein a first wall and a second wall are formed on an inner circumferential surface of the brush assembly between the open end and the brush, said first wall extending in a circumferential direction while projecting radially inwardly, and said second wall being placed to be spaced apart from the first wall on its side closer to the brush than the first wall and forming between it and the first wall, a flow passage that leads in the circumferential direction from a region corresponding to a penetrating region of the brush, to an outside thereof.

2. The rotary electric machine of claim 1, wherein, as the flow passage goes toward both ends thereof in the circumferential direction, it expands so as to become closer to the brush.

3. The rotary electric machine of claim 1, wherein, at the region in the circumferential direction corresponding to the penetrating region of the brush, the flow passage has a width, in an axial direction, of not less than 1 mm but not more than 10 mm.

4. The rotary electric machine of claim 2, wherein, at the region in the circumferential direction corresponding to the penetrating region of the brush, the flow passage has a width, in an axial direction, of not less than 1 mm but not more than 10 mm.
